(19) United States
(12) Patent Application Publication
(10) Pub. No.: US 2010/0323867 A1
(43) Pub. Date: Dec. 23, 2010

(54) Method of Making Paper Packing Box

(76) Inventor: Jian TAO, Shen Zhen City (CN)

Correspondence Address: Jackson Intellectual Property Group PLLC, 106 Starvale Lane, Shipman, VA, 22971, US

(21) Appl. No.: 12/487,724

(22) Filed: Jun. 19, 2009

(51) Int. Cl. B31B 1/26

(52) U.S. Cl. 493/162

(57) ABSTRACT

A method of making a paper packing box of the present invention comprises the following steps: step 1, providing a base board, an inner layer paper, and an outer layer paper; step 2, separately pasting the inner layer paper and the outer layer paper to the two surfaces of the base board; step 3, defining a plurality of grooves at the surface of the base board which is pasted with the inner layer paper, to form a polygonal panel surrounded by the plurality of grooves, and a plurality of side boards connected to the edges of the panel; step 4, providing viscous glue on the side walls of the grooves; step 5, folding the side boards to be substantially vertical to the panel, connecting each side wall of the groove to another corresponding side wall of the groove via viscous glue, thereby forming the finished product of the paper packing box. The method of making a paper packing box of the present invention is simple, and greatly increases the production efficiency, thereby reducing the cost.

### FIELD OF THE INVENTION

The present invention relates to a method of making a packing box, and particularly relates to a method of making paper packing box.

### BACKGROUND OF THE INVENTION

Currently, paper packing boxes are widely used in packing products. A top and bottom type of paper packing box has an inner box and an outer box covering the inner box. The inner and outer boxes are made similarly. A conventional method of making the inner or outer box comprises the steps of: cutting a paper board by die cut, then gluing the four corners to form a blank box; then pasting papers to the surface of the blank box. In the process of pasting papers, the papers are manually positioned at the blank box on a conveyor belt, and then the blank box is sent to a pasting mechanism to be pasted with the papers for forming the finished packing box. However, in the conventional method, the four corners are first glued to form a blank box, and the packing box needs to change the direction for four times to finish pasting the packing box. Since the pasting process needs manual positioning, and the pasting is implemented in two planes that are vertical to each other, the efficiency is comparatively low, which adversely affect the cost of the packing box. Furthermore, this kind of top and bottom packing box needs to occupy large space during storage and transportation, which results in high cost of storage and transportation.

### SUMMARY OF THE INVENTION

An object of the present invention is to provide a method of making a paper packing box, which can simplify the production flow, effectively increase the production efficiency, and reduce the production cost.

Another object of the present invention is to provide a method of making a paper packing box, which assembles the paper packing box when used whereby the paper packing box can be stored and transported as a plane paper board for saving the space of transportation and storage thereby reducing the cost.

To achieve the above objects, a method of making a paper packing box of the present invention comprises the following steps:

step 1, providing a base board, an inner layer paper, and an outer layer paper;

step 2, separately pasting the inner layer paper and the outer layer paper to the two surfaces of the base board;

step 3, defining a plurality of grooves at the surface of the base board which is pasted with the inner layer paper, to form a polygonal panel surrounded by the plurality of grooves, and a plurality of side boards connected to the edges of the panel;

step 4, providing viscous glue on the side walls of the grooves;

step 5, folding the side boards to be substantially vertical to the panel, connecting each side wall of the groove to another corresponding side wall of the groove via viscous glue, thereby forming the finished product of the paper packing box.

The method of making a paper packing box further comprises step 2.1 after step 2. Step 2.1 is to spray paint to the end face of the periphery of the base board, for providing required color to the end face.

Wherein step 2 comprises: the outer layer paper being firstly pasted to the surface of the base board, and the edges of the outer layer paper being pasted to the other surface of the base board; then the inner layer paper being pasted to the other surface of the base board, and covering the edges of the outer layer paper.

Wherein the grooves defined in step 3 are V-shaped grooves or U-shaped grooves.

Wherein in step 4, each side wall of the grooves is provided with viscous glue.

Wherein step 3 comprises: defining a plurality of grooves at the surface of the base board pasted with the inner layer paper; the plurality of grooves being connected to form a polygonal panel surrounded thereby; eliminating parts of the base board connected to the corners of the polygonal panel, and keeping parts of the base board connected to the edges of the panel to form the side boards.

Wherein step 3 comprises: defining four grooves at the surface of the base board pasted with the inner layer paper; the four grooves intersecting to form a rectangular panel surrounded by the four grooves; eliminating parts of the base board connected to the four corners of the rectangular panel, and keeping parts of the base board connected to the four edges of the panel to form the side boards.

Wherein the paper packing box is a top and bottom type of paper packing box.

The method of making a paper packing box of the present invention can simplify the production flow, effectively increase the production efficiency, and reduce the production cost to 50% compared with the conventional method. Since the final assembling step is only need to fold the side boards to be connected with the panel via the viscous glue at the side walls of the grooves, the paper packing box can be stored and transported in a plane as a plane paper board for reducing the occupied space thereby reducing the cost.

The characteristic and the technical solution of the present invention are best understood from the following detailed description with reference to the accompanying figures, but the figures are only for reference and explaining, not to limit the scope of the invention.

### BRIEF DESCRIPTION OF THE DRAWINGS

The technical solution and the beneficial effects of the present invention are best understood from the following detailed description with reference to the accompanying figures and embodiments.

FIG. 1 is a flow chart of a method of making a paper packing box of the present invention;

FIG. 2 is a schematic view of a semi-finished product of a paper packing box made by the method of the present invention for storing and transporting;

FIG. 3 is a schematic view of a finished product of paper packing box made by the method of the present invention.

### DESCRIPTION OF THE PREFERRED EMBODIMENT

To further set forth the technical solution adopted by the present invention to achieve the predetermined objects and the effects, please read the following detailed description and figures according to the present invention; the objects, characteristics and novel features of the present invention will be best understood, but the figures are only for reference and explaining, not to limit the scope of the invention.

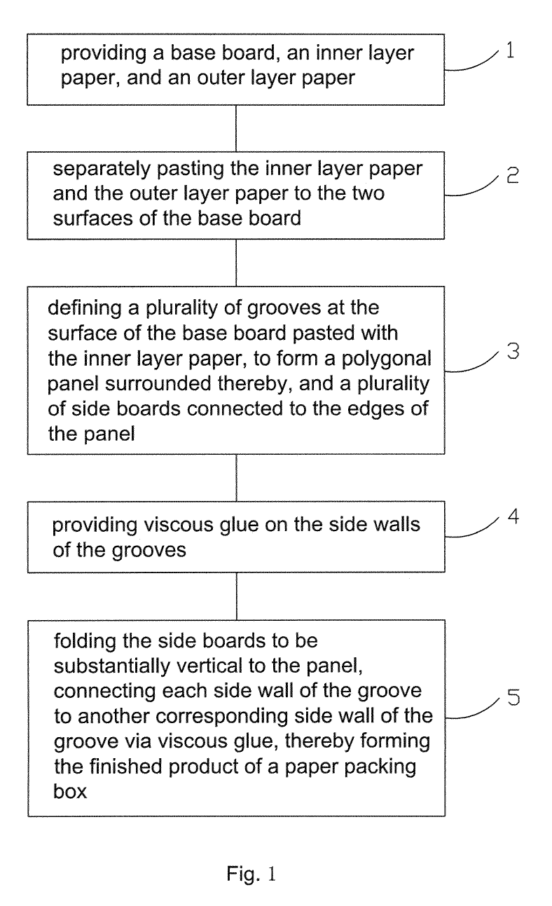

As shown in FIG. 1, a method of making a paper packing box of the present invention comprises the following steps.

Step 1, providing a base board, an inner layer paper, and an outer layer paper. The base board may be a common composite paper board which has a certain strength and toughness, and is capable of loading goods with a certain weight. The price of the composite paper board is cheap, for reducing the production cost. The inner layer paper and the outer layer paper can be the same, and can also be different. The inner layer and outer layer papers are used to paste the base board, and can be printed with patterns or words, according to the requirement.

Step 2, separately pasting the inner layer paper and the outer layer paper to the two surfaces of the base board. In step 2, the pasting operation of the two surfaces of the plane base board is finished in a plane. So, the pasting operation is easy and fast, thereby increasing the efficiency of pasting.

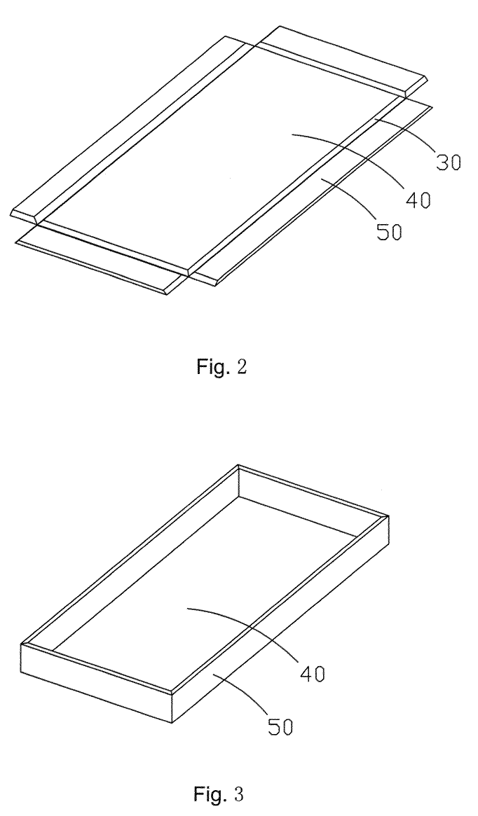

Step 3, defining a plurality of grooves at the surface of the base board which is pasted with the inner layer paper, to form a polygonal panel surrounded by the plurality of grooves, and a plurality of side boards connected to the edges of the panel. Step 3 comprises: defining a plurality of grooves at the surface of the base board which is pasted with the inner layer paper; the plurality of grooves being connected to form a polygonal panel surrounded thereby; eliminating parts of the base board connected to the corners of the polygonal panel, and keeping parts of the base board connected to the edges of the panel to form the side boards. The grooves defined in step 3 are preferably V-shaped grooves or U-shaped grooves. As shown in FIG. 2, step 3 comprises: defining four grooves 30 at the surface of the base board pasted with the inner layer paper; the four grooves intersecting to form a rectangular panel 40 surrounded by the four grooves; eliminating parts of the base board connected to the four corners of the rectangular panel, and keeping parts of the base board connected to the four edges of the panel 40 to form the side boards 50.

Step 4, providing viscous glue on side walls of the grooves. Each side wall of the grooves is provided with viscous glue.

Step 5, folding the side boards along the grooves to be substantially vertical to the panel, connecting each side wall of the groove to another corresponding side wall of the groove via the viscous glue, thereby forming the finished product of a paper packing box, as shown in FIG. 3. The paper packing box is a top and bottom type of paper packing box.

As a selective embodiment, the method of making a paper packing box includes step 2.1 after step 2. Step 2.1, spraying paint to the end face of the periphery of the base board, so as to providing required color to the end face. The paint on the end face of the base board not only increases the aesthetic sensibility of the packing box, but also protects the end face of the packing box at a certain extent thereby increasing the dampproof ability and wear resistance ability of the paper board.

As another selective embodiment, in step 2, the outer layer paper is firstly pasted to the base board surface, and the edges of the outer layer paper are pasted to the other surface of the base board; then the inner layer paper is pasted to the other surface of the base board, and covers the edges of the outer layer paper.

The method of making a paper packing box of the present invention simplifies production steps and increase production efficiency through first pasting the inner and outer layer papers, and then defining grooves. The production cost is reduced to 50%, compared with the conventional method. Moreover, after viscous glue is provided on the side walls of the grooves, the paper packing box can be preliminarily packed in a plane as a plane paper board for storage and transportation. In use of the packing box, the plane packing box is provided, and the side boards are folded along the grooves to be substantially vertical to the panel, each side wall of the groove is connected to another corresponding side wall of the groove via the viscous glue, thereby forming the finished product of a paper packing box. Therefore, the method of making a paper packing box of the present invention reduces the cost of storing and transporting the paper packing box.

Although the present invention has been described in detail with above said embodiments, but it is not to limit the scope of the invention. So, all the modifications and changes according to the characteristic and spirit of the present invention, are involved in the protected scope of the invention.

What is claimed is:

1. A method of making a paper packing box comprising the following steps:
step 1, providing a base board, an inner layer paper, and an outer layer paper;
step 2, separately pasting the inner layer paper and the outer layer paper to the two surfaces of the base board;
step 3, defining a plurality of grooves at the surface of the base board which is pasted with the inner layer paper, to form a polygonal panel surrounded by the plurality of grooves, and a plurality of side boards connected to the edges of the panel;
step 4, providing viscous glue on the side walls of the grooves;
step 5, folding the side boards to be substantially vertical to the panel, connecting each side wall of the groove to another corresponding side wall of the groove via viscous glue, thereby forming the finished product of the paper packing box.

2. The method of making a paper packing box of claim 1, further comprising step 2.1 after step 2, wherein step 2.1 is to spray paint to the end face of the periphery of the base board, for providing required color to the end face.

3. The method of making a paper packing box of claim 1, wherein step 2 comprises: the outer layer paper being firstly pasted to the surface of the base board, and the edges of the outer layer paper being pasted to the other surface of the base board; then the inner layer paper being pasted to the other surface of the base board, and covering the edges of the outer layer paper.

4. The method of making a paper packing box of claim 1, wherein the grooves defined in step 3 are V-shaped grooves or U-shaped grooves.

5. The method of making a paper packing box of claim 1, wherein in step 4, each side wall of the grooves is provided with viscous glue.

6. The method of making a paper packing box of claim 1, wherein step 3 comprises: defining a plurality of grooves at the surface of the base board pasted with the inner layer paper; the plurality of grooves being connected to form a polygonal panel surrounded thereby; eliminating parts of the base board connected to the corners of the polygonal panel, and keeping parts of the base board connected to the edges of the panel to form the side boards.

7. The method of making a paper packing box of claim 1, wherein step 3 comprises: defining four grooves at the surface of the base board pasted with the inner layer paper; the four grooves intersecting to form a rectangular panel surrounded by the four grooves; eliminating parts of the base board connected to the four corners of the rectangular panel, and keeping parts of the base board connected to the four edges of the panel to form the side boards.

8. The production method of paper packing box of claim 1, wherein the paper packing box is a top and bottom type of paper packing box.
